(19) United States
(12) Patent Application Publication
(10) Pub. No.: US 2013/0234944 A1
(43) Pub. Date: Sep. 12, 2013

(54) CIRCUIT AND ASSOCIATED METHOD IDENTIFYING KEYS AND IMPLEMENTING KEYPAD

(71) Applicants: Hao-Jung Li, Zhubei City (TW); Tung-Yi Wang, New Taipei City (TW)

(72) Inventors: Hao-Jung Li, Zhubei City (TW); Tung-Yi Wang, New Taipei City (TW)

(73) Assignee: MEDIATEK Inc., Hsin-Chu (TW)

(21) Appl. No.: 13/418,219

(22) Filed: Mar. 12, 2012

(51) Int. Cl. G06F 3/02

(52) U.S. Cl. 345/168

(57) ABSTRACT

The present invention provides circuit and associated method capable of identifying keys and implementing keypad; the circuit includes a plurality of input nodes and a decoder; each input nodes is associated with multiple keys, and the decoder is capable of distinguishing each of the multiple keys of an input node such that a keypad can be implemented with low pin count.

### FIELD OF THE INVENTION

The present invention relates to circuit and associated method capable of identifying keys and implementing keypad, and more particularly, to circuit and associated method capable of identifying keys efficiently with lower pin count.

### BACKGROUND OF THE INVENTION

Keypad (or keyboard) is one of the most popular techniques to implement a man-machine interface. Keypads are broadly used in portable/personal consumer electronics, such as personal digital assistant (PDA) devices, mobile phones, tablets, and portable computers. A keypad includes many keys, user press the keys to input instruction, data and/or information to the man-machine interface. To identifying which key is pressed, a keypad circuitry, e.g., an integrated circuit or a chip implementing a keypad man-machine interface, is adopted. Key press activities are transformed to electric signals, then the keypad circuitry receives the electric signals with pins and distinguishes key pressed accordingly. As more and more functions and utilities are integrated into an electronic device, the electronic device may need a keypad of more keys for a sophisticated man-machine interface. For example, a full QWERTY keypad for convenient text input needs about fifty keys. However, more keys demands more pins to be identified, and pin count is an expensive resource of a keypad circuitry.

Please refer to FIG. 1 illustrating a keypad 10 in association with a keypad circuitry 12 of a prior art. The keypad circuitry 12 includes row pins kr(1), kr(2), . . . , kr(m) to kr(M) and column pins kc(1), kc(2), . . . , kc(n) to kc(N) for identifying M*N keys of the keypad 10, such as keys K(1,1), K(1,2), . . . , K(1,n) to K(1,N), K(2,1), . . . , K(m,1) to K(m,n) and finally K(M,N). Each key K(m,n) includes a conductive contact c(m) coupled to the m-th row pin kr(m) and a conductive contact s(n) coupled to the n-th column pin kc(n), so the keys K(1,n), . . . , K(m,n) to K(M,n) have contacts commonly coupled to the same column pin kc(n), and the keys K(m,1), K(m,2) to K(m,N) have contacts commonly coupled to the same row pin kr(m).

In the key K(m,n), the contacts s(n) and c(m) are mutually isolated and are covered by a conductive dome d(m,n); the dome d(m,n) is in contact with the contact s(n). When the key K(m,n) is not pressed, the dome d(m,n) remains isolated from the contact c(m); when the key K(m,n) is pressed, the dome d(m,n) deforms to engage the contact c(m), and then the contacts c(m) and s(n) are electrically wired together.

The keypad circuitry 12 identifies keys by periodically scanning through the row pins kr(1) to kr(M) respectively during different time slots. During (m+M*Q)-th time slot (where Q is an integer), the keypad circuitry 12 supplies a high voltage through the row pin kr(m) with the rest of row pins kept at a low voltage, and detects voltage status of the column pins kc(1) to kc(N) for distinguishing keys K(m,1) to K(m,N). If the key K(m,n) is pressed, the corresponding column pin kc(n) is in contact with the row pin kr(m) by the deformed dome d(m,n), thus the pin kc(n) is pulled to high voltage by the row pin kr(m). On the contrary, if the key K(m,n) is not pressed, the column pin kc(n) keeps isolated from the row pin kr(m), and the voltage status of the column pin kc(n) will not be pulled to the high voltage. Therefore, whether the keys K(m,1) to K(m,N) are pressed can be detected during the (m+M*Q)-th time slot. To detect whether the other keys K(m+1,1) to K(m+1,N) are pressed, the keypad circuitry 12 starts the (m+1+M*Q)-th time slot, during which the keypad circuitry 12 supplies a high voltage through the row pin kr(m+1), keeps the rest of row pins at a low voltage, and again detects voltage status of the column pins kc(1) to kc(N) for identification of keys K(m+1,1) to K(m+1,N).

In the prior art keypad circuitry 12, the row pins kr(1) to kr(M) work as M stimulating pins sequentially enabling and preparing each set of keys K(m,1) to K(m,N) to be identified, and the column pins kc(1) to kc(N) work as N input nodes detecting key press. For a keypad of M*N keys, the keypad circuitry 12 needs M+N pins. It is noticed that during a same time slot, only N keys K(m,1) to K(m,N) corresponding to the N column pins kc(1) to kc(N) are identified, that is, no more than N keys are identified simultaneously.

The voltage status of each column pin can be considered as a status bit reflecting either a logic 1 (e.g., high voltage) or otherwise a logic 0. Thus the column pins kc(1) to kc(N) can be orderly listed to form a status word, and key press can be identified by matching the status word with a plurality of key-mapping words. For example, the key K(m,1) corresponds to an N-bit key-mapping word “10 . . . 0”, the key K(m,2) maps to another N-bit key-mapping word “010 . . . 0”, and the key K(m,N) maps to the N-bit key-mapping word “0 . . . 01”. It is therefore observed that the key-mapping word which corresponds to a single key press has only one bit of logic 1.

It is also understood that although each column pin kc(n) is coupled to M keys K(1,n) to K(1,M), these M keys of a same column pin are not identified at a same time; they are respectively distinguished during different time slots. In addition, each key K(m,n) has only one contact s(n) coupled to a corresponding column pin kc(n) (i.e. the n-th input node).

### SUMMARY OF THE INVENTION

To enhance pin count usage, the invention provides key identification and keypad implementation technology which distinguish more keys with fewer pins.

An objective of the invention is to provide a circuit identifying key pressed among a plurality of keys, including: a plurality of input nodes, each of the input nodes capable of receiving a corresponding status bit which has two or more different status alternatives; and a decoder capable of simultaneously distinguishing key pressed among the plurality of keys by matching a status word with a plurality of key-mapping words, wherein the status word is an orderly list of the status bits corresponding to the plurality of input nodes, and a quantity of the plurality of keys is greater than that of the plurality of input nodes.

An objective of the invention is to provide a circuit identifying key pressed, comprising: a plurality of input nodes, each of the input nodes corresponding to a status bit, and capable of detecting key press by a transition from a default status to an engaged status; and a decoder capable of identifying key pressed by matching a status word with a plurality of key-mapping words, wherein the status word is an orderly list of the status bits corresponding to the plurality of input nodes, each of the key-mapping words maps to one of the plurality of keys and includes a plurality of bits with each bit selected from the default status and the engaged status; wherein one of the key-mapping words includes two bits equal to the engaged status.

An objective of the invention is to provide a circuit identifying key pressed among a plurality of keys, including: an input node associated with multiple keys among the plurality of keys and capable of receiving a corresponding status from the associated multiple keys; and a decoder capable of distinguishing each of the associated multiple keys at a same time according to the status.

An objective of the invention is to provide a method implementing a keypad comprising a plurality of keys and a plurality of input contacts for the plurality of keys, including: providing a circuit with a plurality of input nodes, each of the plurality of input nodes coupled to one of the input contacts and capable of receiving a corresponding status from the coupled input contact, and associating multiple input contacts to one of the keys.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) illustrates prior art keypad implementation;

FIG. 2 illustrates a keypad implementation according to an exemplary embodiment of the invention;

FIG. 3 illustrates a keypad implementation according to an embodiment of the invention; and

FIG. 4, FIG. 5 and FIG. 6 illustrate contact layout for key implementation according to embodiments of the invention.

### DETAILED DESCRIPTION OF PREFERRED EMBODIMENTS

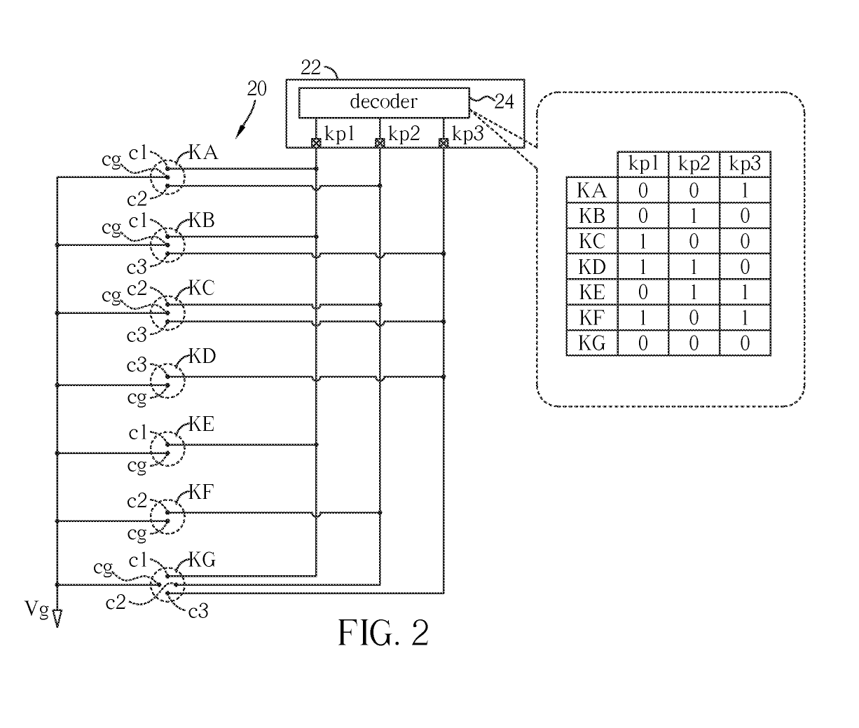

Please refer to FIG. 2 illustrating a keypad 20 in association with a circuit 22 according to an exemplary embodiment of the invention. The circuit 22 can be a keypad circuitry, such as an integrated circuit, a chip and/or a baseband processor for a mobile phone which needs to implement a keypad for men-machine interface. In the example of FIG. 2, the circuit 22 uses three input nodes kp1, kp2 and kp3 (e.g., pins or balls of chip) to implement seven keys KA, KB, KC, KD, KE, KF and KG for the keypad 20.

Each of the keys KA, KB, KE and KG can include an input contact c1 coupled to the input node kp1. Each of the keys KA, KC, KF and KG can include an input contact c2 coupled to the input node kp2. Each of the keys KB, KC, KD and KG can include an input contact c3 coupled to the input node kp3. Every one of the seven keys KA to KF can include a bias contact cg, and, in this embodiment, all the bias contacts cg can be commonly coupled to a voltage Vg, e.g., a ground voltage. The input contacts c1, c2 and/or c3 of a same key can be mutually isolated; also the input contact(s) and the bias contact of a same key can be mutually isolated. To detect key press, each of the input nodes kp1 to kp3 can be preset to a voltage Vh, e.g., a dc power voltage higher (greater) than the voltage Vg. When a given key is pressed, the input and bias contacts of the given key can be short wired together, so the input node(s) coupled to the input contact(s) of the given key will be conducted to the voltage Vg and thus experience a transition from the voltage Vh to the voltage Vg.

For example, if a single key KA is pressed, voltages of the input nodes kp1 and kp2 can be changed from the voltage Vh to the voltage Vg, while the input node kp3 remains the default voltage Vh. If the key KE is pressed, only the input node kp1 is changed to the voltage Vg. If the key KG is pressed, all the input nodes kp1, kp2 and kp3 can be conducted to the voltage Vg. The voltage of an input node can be considered as a status bit received by the input node. For example, if an input node detects the voltage Vg, it can be considered as receiving a logic 0 status bit of an engaged status; if the input node remains the voltage Vh, it can be considered as receiving a logic 1 status bit of a default status. A status word is therefore formed as an orderly list of the status bits of all the input nodes. For example, status bits of the input nodes kp1, kp2 and kp3 respectively contribute to the first, second and third bits of a three-bit status word.

On the other hand, each key can correspond to a key-mapping word. For example, the key KA can correspond to a key-mapping word “001”, because when the key KA is pressed, the input nodes kp1 and kp2 can detect engaged status represented by logic 0, while the input node kp3 can receive a default status represented by logic 1. Similarly, the key KD can be mapped to a key-mapping word “110” and the key KG can be mapped to a key-mapping word “000”.

Accordingly, the keys KA to KG can be identified by a decoder 24 of the circuit 22. The decoder 24 is capable of distinguishing key pressed by matching a status word of the input nodes with the key-mapping words of the keys. For example, if the input nodes kp1 to kp3 receive a status word “001”, the decoder 24 can identify that the key KA is pressed since the status word meets the key-mapping word of the key KA. Similarly, a status word “100” can be decoded to identify key press of the key KC, and a status word “000” reflects that the key KG is pressed.

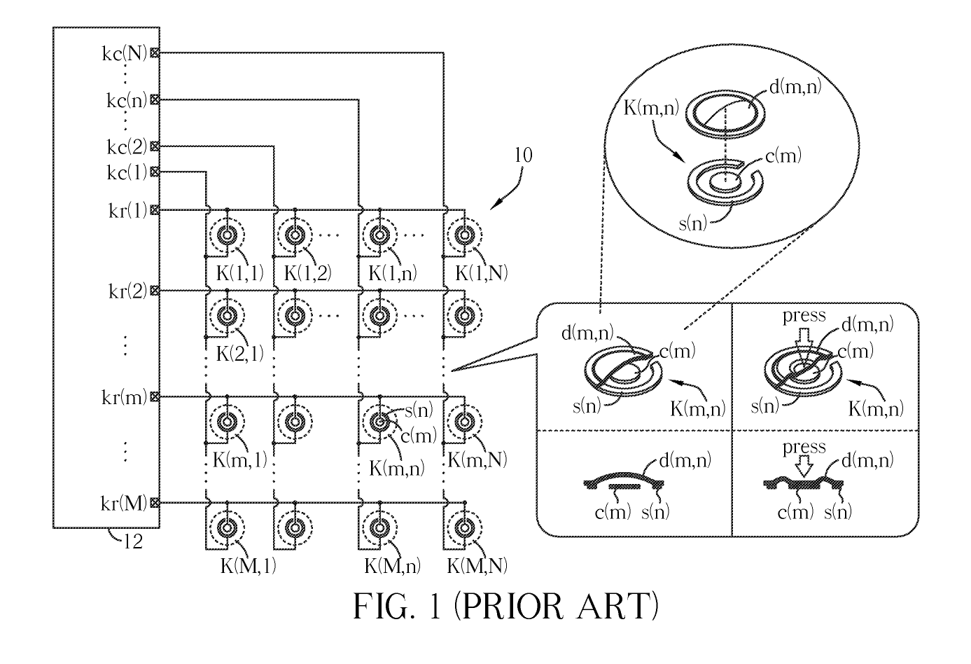

It is noticed that seven keys can be implemented with only three pins (input nodes) according to the invention, while three pins (a row pin and two column pins) can merely implement two keys according to prior art of FIG. 1. Therefore the invention can greatly reduce pin count required for a keypad.

At a same time (a same time slot), the prior art of FIG. 1 distinguishes N keys K(m,1) to K(m,N) with the same quantity of input nodes kc(1) to kc(N). On the contrary, the disclosure of the invention is capable of distinguishing keys more than the quantity of the input nodes. In the example of FIG. 2, seven keys KA to KG can be distinguished simultaneously with fewer (three) input nodes kp1 to kp3. That is, according to the invention, the quantity of the keys to be distinguished simultaneously is greater than that of the input nodes.

The prior art of FIG. 1 maps each single key press to a key-mapping word containing only one bit equal to an engaged status represented by a logic 1. For example, a single key press of the key K(m,1) corresponds to a key-mapping word “10 . . . 0”. On the contrary, more bits equal to the engaged status can be used according to the invention; that is, a key can be implemented with multiple input contacts coupled to multiple input nodes. For example of FIG. 2, a single key press of the key KA can be implemented with input contacts c1 and c2 and correspond to a key mapping word “001” with the former two bits equal to the engaged status represented by logic 0.

According to the prior art of FIG. 1, for the keys K(m,1) to K(m,N) to be simultaneously distinguished during a same time slot, each of the input nodes kc(1) to kc(N) is associated to only one key; that is, the n-th input node kc(n) is associated to only the key K(m,n). On the contrary, according to the invention, a single input node can be associated to multiple keys which can be distinguished at a same time. For example, the input node kp1 can be associated to the keys KA, KB, KE and KG, all these keys can be distinguished simultaneously.

With the contacts cg coupled to the voltage Vg, row pins of prior art are no longer needed according to the invention, thus the pin count for a keypad can be reduced or the pin count can be fully utilized to implement the input nodes which detect key press. Then a keypad can be implemented with less pin counts, or a keypad with more keys can be implemented by the same amount of pin count. To compare pin count usage efficiency, the prior art use J pins to implement (J/2)*(J/2) (if J is even) or (J+1)*(J−1))/4 (if J is odd) keys. According to the invention, J pins can implement a maximum quantity of (2̂J−1) keys, since a key-mapping word of J bits have 2̂J possible alternatives with one alternative “1 . . . 1” of all bits equal to logic 1 being excluded. For example, the prior art uses 14 pins (7 row pins and 7 column pins) to implement 49 keys. According to the invention, 6 pins can implement a maximum quantity of 63 keys.

Because pin count is utilized with high efficiency, the invention is capable of providing redundancy for key mapping. With the redundancy, some of possible key-mapping words are not mapped to any key. For example, if the keypad 20 of FIG. 2 needs only six keys, then one alternative of possible key-mapping words, e.g., “000”, does not have to be mapped to any key, and it can be excluded from key-mapping. The redundancy can be utilized to resolve ambiguity of key combination. In some application, a first key can be used with a second key to form a key combination; if only the first key is pressed, a first function is triggered, and if the first and second keys are pressed, a different second function is triggered. To support key combination, simultaneous multiple key presses need to be distinguished against possible ambiguity. As an example, if a status word “001” is detected, it is possible that the key KA alone is pressed, or the keys KE and KF are pressed together, etc. However, such ambiguity can be eliminated if involved alternatives of possible key-mapping words have been excluded from key-mapping.

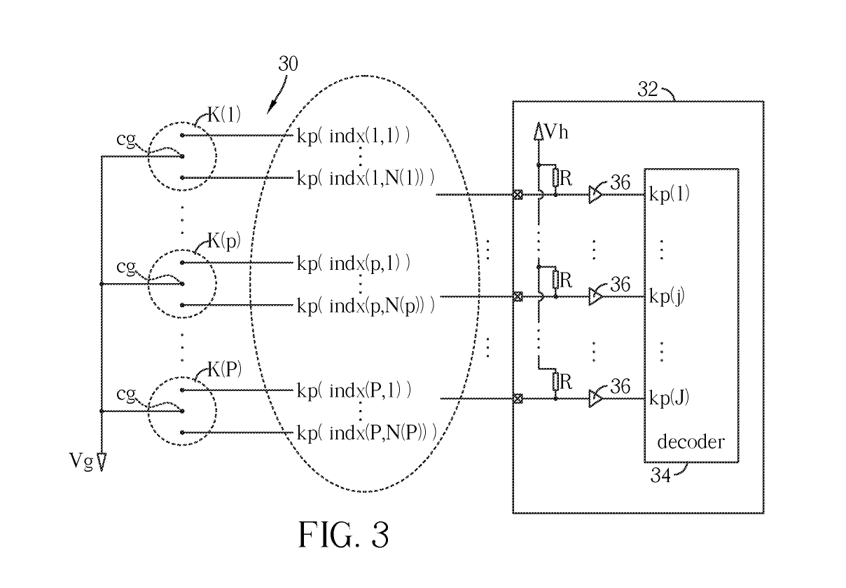

Please refer to FIG. 3 illustrating a generalized keypad 30 and an associated circuit 32 according to an embodiment of the invention. The circuit 32 can include J input nodes kp(1) to kp(J) coupled to a decoder 34 to implement P keys K(1) to K(P) of the key pad 30. Each input node, such as a digital input node, kp(j) is capable of receiving status through an input circuit (e.g., a receiver) 36, and can be preset to the voltage Vh through a corresponding load (e.g., a resistor) R coupled between the input node kp(j) and the voltage Vh. Each key K(p) can be implemented by a bias contact cg coupled to the voltage Vg and N(p) mutually isolated input contact(s) respectively coupled to the input node(s) kp(indx(p,1)) to kp(indx(p,N(p)), where N(p) can be greater than or equal to 1. Different keys can be implemented with the same or different numbers of input contacts.

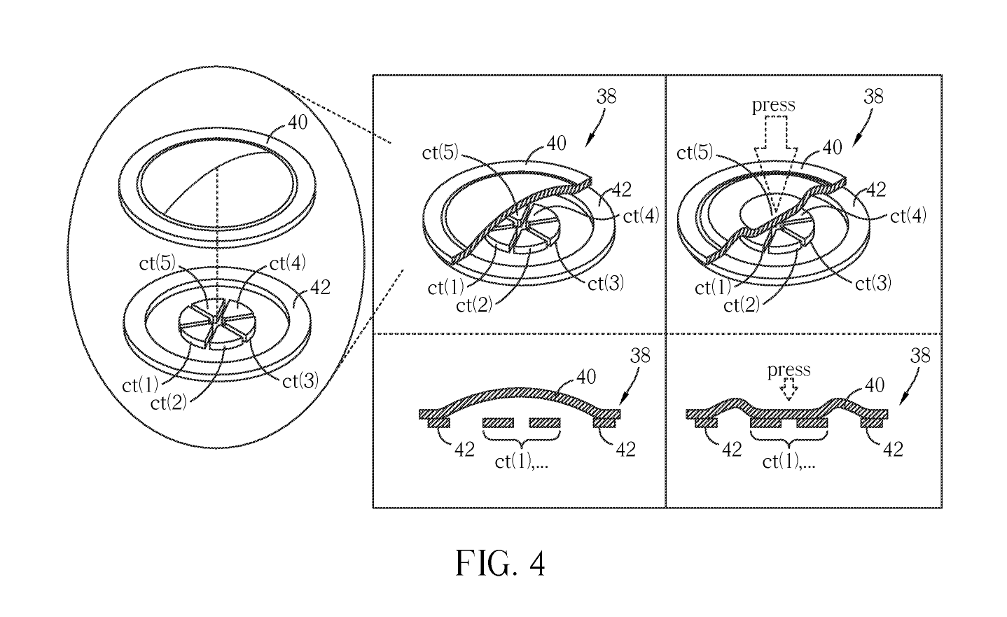

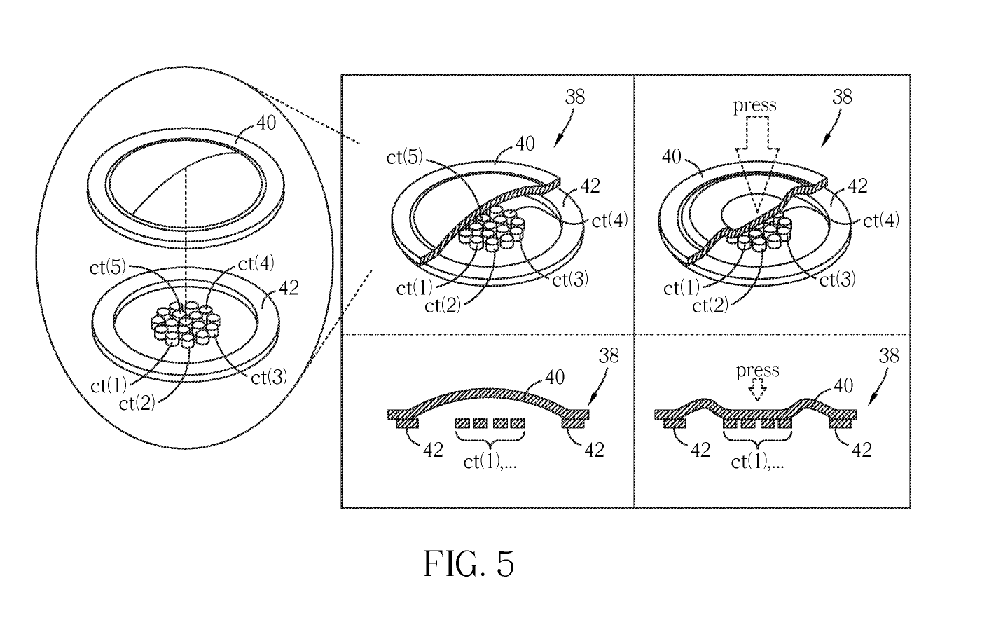

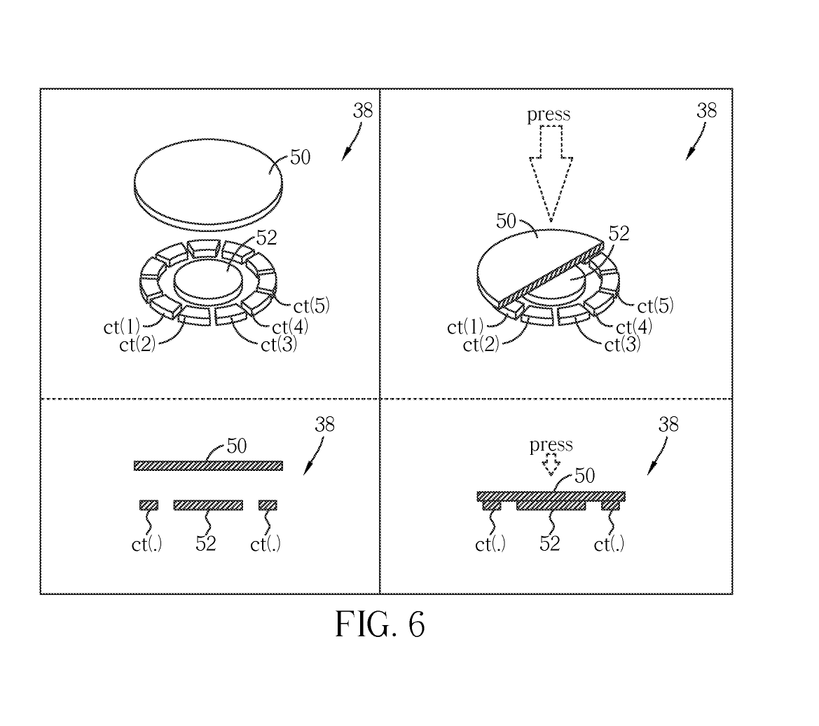

Please refer to FIG. 4, FIG. 5 and FIG. 6 respectively illustrating contact layout to implement a key 38 according to embodiments of the invention. The key 38 can be one of the keys KA to KG shown in FIG. 2, or one of the keys K(1) to K(P) shown in FIG. 3. In the exemplary embodiments of FIG. 4 and FIG. 5, a conductive bias contact 42 can be coupled to the voltage Vg and surround one or multiple conductive central contacts coupled to input node(s) of the decoder (not shown), such as contacts ct(1) to ct(5). The bias contacts 42 and the central contacts (e.g., ct(1) to ct(5)) can be formed on a plane such as a circuit board (not shown) and are mutually isolated. A conductive dome 40 can be attached to the contact 42 and cover above the central contacts. When the key 38 is pressed, the dome 40 can (elastically) deform, so the bias contact 42 and the central contacts can be electrically short, and then the central contacts ct(1), ct(2), . . . can be all conducted to the voltage Vg of the contact 42.

The central contacts ct(1), ct(2), . . . etc can work as the input contacts of FIG. 2 and FIG. 3; different central contacts can be coupled to a same input node or coupled to different input nodes. For example, to implement the key KG of FIG. 2, the central contacts ct(1) and ct(4) of different locations can be commonly coupled to the input node kp1 as the input contact c1 of FIG. 2, the central contacts ct(2) and ct(5) can be commonly coupled to the input node kp2 as the input contact c2, etc. With central contacts of different locations are combined to implement a same input contact, a voltage status transition can be surely detected even when the dome 42 is not uniformly deformed. Or, a key implementing the key KG of FIG. 2 can have only three central contacts ct(1) to ct(3) respectively as the three input contacts c1 to c3.

In the example of FIG. 6, a central contact 52 can be coupled to the voltage Vg, and can be surrounded by one or more peripheral contacts, e.g., contacts ct(1), ct(2), . . . etc. The central contacts 52 can be a bias contact and the peripheral contacts can be input contacts. The central contacts 52 and the peripheral contacts can be mutually isolated, and a conductive connecting contact 50 can be set above them by a supporting mechanism (not shown). When the key is pressed, the connecting contact 50 can engage with the central contact 52 and the peripheral contacts, such that the peripheral contacts can be conducted to the voltage Vg of the central contact 52.

To sum up, comparing to prior art, the invention discloses key implementation with pin count more efficiently utilized, so lower pin count and thus more cost reduction for keypad can be achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A circuit identifying key pressed among a plurality of keys, comprising:
a plurality of input nodes, each of the input nodes capable of receiving a corresponding status bit which has two or more different status alternatives; and
a decoder capable of simultaneously distinguishing key pressed among the plurality of keys by matching a status word with a plurality of key-mapping words, wherein the status word is an orderly list of the status bits corresponding to the plurality of input nodes, and a quantity of the plurality of keys is greater than that of the plurality of input nodes.

2. The circuit as claimed in claim 1 further comprising:
a plurality of loads respectively corresponding to the plurality of input nodes, each of the loads coupled between the corresponding input node and a first voltage; wherein each of the input nodes is capable of receiving one of the status alternatives when it is conducted to a second voltage which is different from the first voltage, and receiving another of the status alternatives when it is not conducted to a second voltage.

3. The circuit as claimed in claim 2, wherein the first voltage is greater than the second voltage.

4. The circuit as claimed in claim 2, wherein the second voltage is a ground voltage.

5. A circuit identifying key pressed among a plurality of keys, comprising:
a plurality of input nodes, each of the input nodes corresponding to a status bit, and capable of detecting key press by a transition from a default status to an engaged status; and
a decoder capable of identifying key pressed by matching a status word with a plurality of key-mapping words, wherein the status word is an orderly list of the status bits corresponding to the plurality of input nodes, each of the key-mapping words maps to one of the plurality of keys and includes a plurality of bits with each bit selected from the default status and the engaged status; wherein one of the key-mapping words includes two bits equal to the engaged status.

6. The circuit as claimed in claim 5 further comprising:
a plurality of loads respectively corresponding to the plurality of input nodes, each of the loads coupled between the corresponding input node and a first voltage; wherein each of the input nodes is capable of receiving the engaged status when it is conducted to a second voltage which is different from the first voltage, and receiving the default status when it is not conducted to the second voltage.

7. The circuit as claimed in claim 6, wherein the first voltage is greater than the second voltage.

8. The circuit as claimed in claim 6, wherein the second voltage is a ground voltage.

9. A circuit identifying key pressed among a plurality of keys, comprising:
an input node associated with multiple keys among the plurality of keys and capable of receiving a corresponding status from the associated multiple keys; and
a decoder capable of distinguishing each of the associated multiple keys at a same time according to the status.

10. The circuit as claimed in claim 9, wherein the status has two or more different status alternatives, and the circuit further comprises:
a load coupled between the input node and a first voltage; wherein the input node receives one of the status alternatives when it is conducted to a second voltage which is different from the first voltage, and receives another of the status alternatives when it is not conducted to the second voltage.

11. The circuit as claimed in claim 10, wherein the first voltage is greater than the second voltage.

12. The circuit as claimed in claim 10, wherein the second voltage is a ground voltage.

13. A method capable of implementing a keypad comprising a plurality of keys and a plurality of input contacts for the plurality of keys, the method comprising:
providing a circuit with a plurality of input nodes, each of the plurality of input nodes coupled to one of the input contacts and capable of receiving a corresponding status from the coupled input contact; and
associating multiple input contacts of the plurality of the input contacts to one of the keys.

14. The method as claimed in claim 13 further comprising:
providing a plurality of loads respectively corresponding to the input nodes, each of the loads coupled between the corresponding input node and a first voltage.

15. The method as claimed in claim 14, the keypad further comprising:
a bias contact for each of the plurality of keys, wherein the bias contacts of the plurality of keys are commonly coupled to a second voltage which is different from the first voltage.

16. The method as claimed in claim 15, wherein the first voltage is greater than the second voltage.

17. The method as claimed in claim 15, wherein the second voltage is a ground voltage.

18. The method as claimed in claim 13, the keypad further comprising:
a bias contact for each of the plurality of keys, wherein the bias contacts of the plurality of keys are commonly coupled to a predetermined voltage.

19. The method as claimed in claim 13, wherein at least one of the input nodes is coupled to multiple input contacts of different keys.

20. The method as claimed in claim 13, wherein the multiple input contacts for the plurality of keys include a first input contact and a second input contact associated to a first key of the keys, and include a third input contact associated to a second key of the keys, wherein the first input contact and the third input contact are commonly coupled to a first input node of the input nodes, and the second input contact is coupled to a second input node of the input nodes.
